(19) United States
(12) Patent Application Publication
(10) Pub. No.: US 2013/0206901 A1
(43) Pub. Date: Aug. 15, 2013

(54) SMALL ARMS CLASSIFICATION/IDENTIFICATION USING BURST ANALYSIS

(71) Applicants: Carl R. Herman, Owego, NY (US); Steven V. Czarnecki, Apalachin, NY (US); Robert K. Boatman, Binghamton, NY (US)

(72) Inventors: Carl R. Herman, Owego, NY (US); Steven V. Czarnecki, Apalachin, NY (US); Robert K. Boatman, Binghamton, NY (US)

(21) Appl. No.: 13/397,118

(22) Filed: Feb. 15, 2012

(51) Int. Cl. B64D 45/00

(52) U.S. Cl. 244/1 R

(57) ABSTRACT

Systems and methods are provided for differentiating weapon fire from targets on the ground to an aircraft such that appropriate countermeasures can be taken. A plurality of shots from a target on the ground is detected from a sensor in the aircraft. Shots belonging to a single burst are correlated. A firing characteristic of the plurality of shots in the burst is computed. A weapon type is determined for the plurality of shots based on the firing characteristic.

### TECHNICAL FIELD

The present invention relates to electronic systems, and specifically relates to a small arms classification system for an aircraft.

### BACKGROUND OF THE INVENTION

Aircraft are used in a wide variety of applications, both civilian and military, including travel, transportation, fire fighting, surveillance, and combat. Various aircraft have been designed to fill the wide array of functional roles defined by these applications, including balloons, dirigibles, traditional fixed wing aircraft, flying wings, and helicopters.

In general, aircraft travel at a sufficient altitude to substantially eliminate any threat posed to the aircraft from targets posed by personnel on the ground. For some applications, however, it is necessary to travel at comparably low altitudes for long periods of time, placing the aircraft within range of weapon fire from the ground. Similar exposure takes place in other applications during take-offs and landings of the aircraft. In one example, due to battlefield conditions, the weapon fire within the immediate area of the aircraft may constitute both hostile and friendly fire. It may become important, therefore, for the aircraft to differentiate between enemy weapon fire that may require appropriate countermeasures to be taken and friendly fire requiring no countermeasures.

### SUMMARY OF THE INVENTION

In accordance with one aspect of the present invention a method is provided for differentiating weapon fire from targets located on the ground to an aircraft. A plurality of shots from a target on the ground is detected from a sensor in the aircraft. Shots belonging to a single burst are correlated. A firing characteristic of the plurality of shots in the burst is computed. A weapon type is determined for the plurality of shots based on the firing characteristic.

In accordance with another aspect of the present invention, a system is provided for differentiating weapon fire from targets on the ground to an aircraft. The system includes a weapon fire detection element configured to detect a plurality of shots from a target on the ground to the aircraft. A burst definition element is configured to correlate shots that belong to a single burst. A firing characteristic element is configured to compute a firing characteristic of the plurality of shots in the burst. A weapon identification element is configured to determine the weapon type for the plurality of shots in the burst based on the firing characteristic.

In accordance with yet another aspect of the present invention, a computer readable medium is provided for storing executable instructions that can be executed by a processor to differentiate weapon fire from targets on the ground to an aircraft using sensor data. The executable instructions include a burst definition element configured to determine if a plurality of shots detected from the ground belong to a single burst. A weapon identification element identifies the type of weapon from which the detected shots in the single burst originate.

### BRIEF DESCRIPTION OF THE DRAWINGS

The foregoing and other features of the present invention will become apparent to one skilled in the art to which the present invention relates upon consideration of the following description of the invention with reference to the accompanying drawings, wherein:

FIG. 1 illustrates a system for differentiating weapon fire from targets on the ground to an aircraft in accordance with an aspect of the present invention;

FIG. 2 illustrates a diagram of an aircraft utilizing a weapon identification system in accordance with an aspect of the present invention and a target to the aircraft;

FIG. 3 illustrates a graph representing a series of detected shots of weapon fire from the target in accordance with an aspect of the present invention;

FIG. 4 illustrates a graph representing various fire cycle frequencies and flash intensities for known automatic weapon fire;

FIG. 5 illustrates an exemplary weapon differentiation system for differentiating weapon fire from targets located on the ground to an aircraft;

FIG. 6 illustrates a method for differentiating weapon fire from targets on the ground to an aircraft in accordance with an aspect of the present invention; and

FIG. 7 illustrates a computer system that can be employed to implement systems and methods described herein, such as based on computer executable instructions running on the computer system.

### DETAILED DESCRIPTION OF THE INVENTION

The present invention relates to systems and methods for differentiating weapon fire from targets on the ground to an aircraft such that appropriate countermeasures can be taken. Visual or auditory sensors can be utilized to detect a plurality of shots from a target on the ground to the aircraft. The bearing to the target, i.e., the direction from the aircraft to the target, can be determined for each detected shot. In accordance with an aspect of the present invention, a larger number of bearings to the target can be taken, for example, from each shot in a series of automatic gunfire. The series of shots can be correlated to a single burst of weapon fire. A firing characteristic of the burst can be computed such that the type or class of weapon from which the plurality of shots originated can be determined.

FIG. 1 illustrates a system 10 for differentiating weapon fire from targets on the ground to an aircraft in accordance with an aspect of the present invention. The system 10 includes a shot detection element 12 that is configured to detect a plurality of shots from a target on the ground to an aircraft. The shot detection element 12 may include a bearing determination element that is configured to determine associated bearings from the aircraft to each of the plurality of detected shots from a target at ground level. Specifically, the bearing determination element identifies shots of weapon fire from the ground and determines the direction of incidence of light from a muzzle flash from each shot. Accordingly, the bearing determination element can include one or more sensor elements for detecting the light emitted by the shots, as well as appropriate circuitry or software for calculating the bearing from the aircraft to the detected shot.

The shot detection element 12 can also receive input from other aircraft systems (not shown) indicating at least one of the position, velocity, and orientation of the aircraft, such that at least a relative position of the aircraft can be determined at the time each shot is detected. Accordingly, each detected shot can have an associated determined bearing and position of the aircraft.

A burst definition element 14 is configured to correlate shots from the group of detected shots that represent a single burst of automatic weapon fire from the target on the ground. This can be accomplished by grouping shots that are spatially and temporally proximate. For example, a series of detected shots can be identified as originating from a single burst, i.e., from a single automatic weapon, when a group of shots are within a given degree of arc on the sensor, consecutive shots are separated by no more than a first threshold time period, and the entire burst has a time period less than a second threshold time period,

Once the burst definition element 14 identifies a single burst, a firing characterization element 16 computes a firing characteristic of the plurality of shots in the burst. The firing characterization element 16 may, for example, compute the flash frequency of the shots using time domain and/or frequency domain analysis. This may include, but is not limited to, computing the cyclic rate of the shots within burst, the magnitude of the shots within the burst, and the flash intensity of the shots within the burst.

Once the firing characterization element 16 computes the firing characteristic of the shots within the burst, a weapon identification element 18 compares the firing characteristic with that of known weapon types in order to identify the weapon class or type corresponding having that firing characteristic. This identified weapon class can be reported to an operator, along with a confidence value for weapon type. Since the weapon identification element 18 determines the weapon class of the shots within the burst, the weapon identification element likewise determines if the weapon class is of an enemy or friendly nature to allow appropriate countermeasures to the target to be pursued, if appropriate.

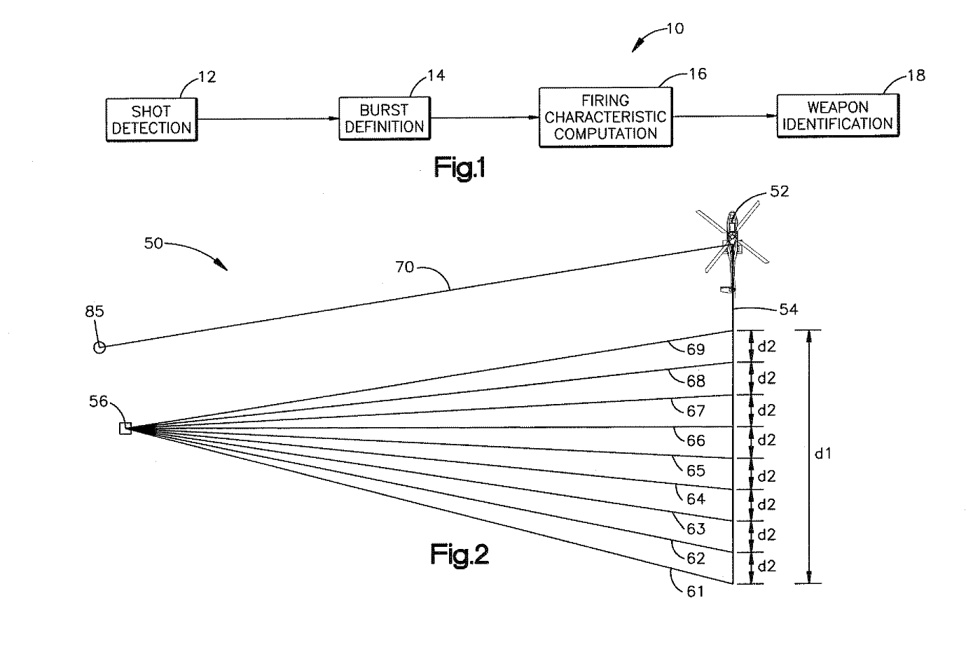

FIG. 2 illustrates a diagram 50 of an aircraft 52 utilizing a weapon differentiation system in accordance with an aspect of the present invention and a target 56 to the aircraft. In the diagram, for the purpose of example, the aircraft 52 is assumed to be travelling at a constant velocity in a straight line, such that a displacement along a flight path 54 of the aircraft is functionally equivalent to the passage of a period of time. It will be appreciated, however, that the system constructed in accordance with the present invention is not limited to use in air travel at a constant velocity and that the system can include or be operatively connected to mechanisms for measuring both a current position of an aircraft and the passage of time. Furthermore, it will be appreciated that the flight path 54 of the aircraft 52 may be arcuate, multi-directional or otherwise non-linear and/or non-planar.

For each of a plurality of shots taken by the target 56 at ground level, a bearing can be taken from the aircraft 52 to the target. For example, a muzzle flash from a weapon used by the target 56 can be imaged by the aircraft 52 and a bearing can be determined via time of arrival measurements. In accordance with an aspect of the present invention, the time interval between consecutive shots can be reviewed to determine which shots belong to a single burst of automatic weapon fire. By reviewing the shot timing, it is possible to discount data that might come from a different target 85. Although the different target 85 is illustrated as being spatially displaced from the target 56, it will be appreciated that both targets could be positioned in close proximity with one another.

In the illustrated diagram, the shots corresponding to the first nine bearings 61-69 occur within relatively short periods of time from one another, while the shot corresponding to the final bearing 70 occurs significantly later. This final shot and, thus, the final bearing 70, is removed from consideration in correlating the shots into a single burst. Although nine bearings 61-69 are illustrated, it will be appreciated that more or fewer bearings may be detected.

Each of the remaining bearings 61-69 associated with the target 56 is separated by an associated distance d₂. Together, the distances d₂ between all consecutive pairs of bearings corresponds with a distance d₁, or baseline, of the flight path 54 over which the target 56 is detected. Although the distance d₂ between each consecutive pair of bearings 61-69 is illustrated as being uniform, the distance between any two consecutive bearings could be the same as, or different from, any other pair of consecutive bearings.

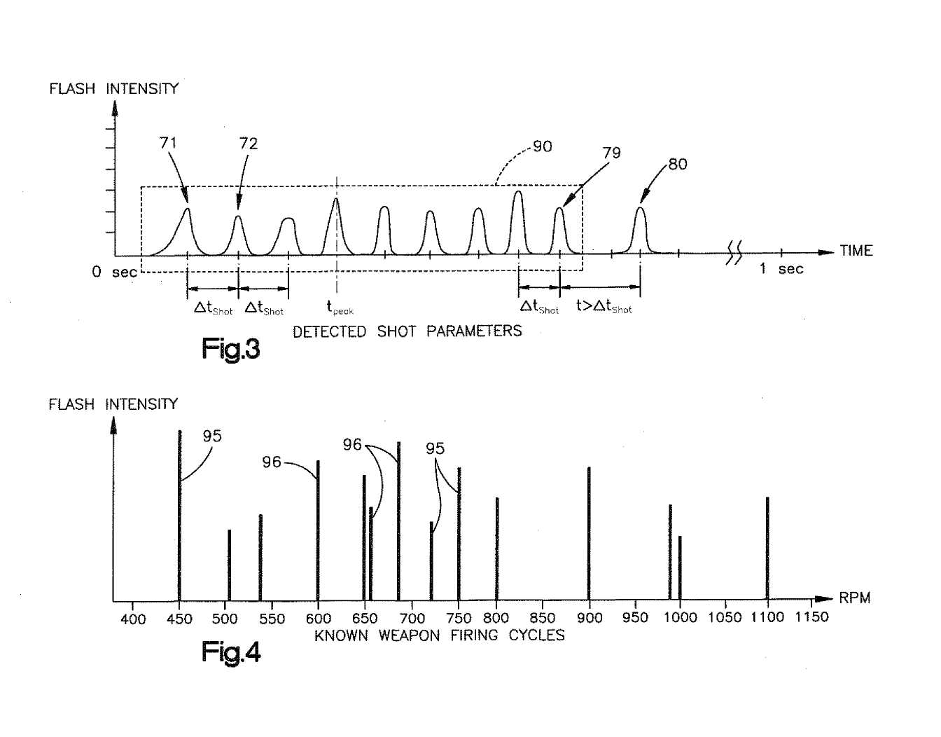

The shots 71-80 associated with the bearings 61-70, respectively, are evaluated to determine whether the shots originate from a single burst or source of weapon fire. When the shots 71-80 are acquired, the sensor(s) obtain and record multiple parameters associated with each shot. This may include, but is not limited to, the range at which the shot was acquired, i.e., the distance between the aircraft and the target, the intensity of the muzzle flash from the weapon fire, and a time stamp indicating the time at which the shot was detected. In one embodiment of the present invention, once the series of shots 71-80 has been detected, the flash intensity of each shot is plotted over time (FIG. 3). Over the duration of a shot, the flash intensity at the muzzle of the weapon increases to a peak or maximum intensity, having a relative time stamp illustrated at tₚₑₐₖ, and then decreases to zero. The peak muzzle flash may be substantially the same for each of the shots 71-80 or may vary between shots. Regardless, the burst definition element 14 evaluates each successive shot in the series and determines the intershot timing based on the difference in time between successive peak muzzle flash time stamps tₚₑₐₖ, indicated at Δtₛₕₒₜ.

In particular, as long as the time interval between each consecutive detected peak muzzle flash in the series is measured to be the same, within a predetermined threshold, then the shots corresponding to those peak muzzle flashes are considered to be in the same burst and from the same source of weapon fire. Together, the flash intensity and the intershot timing provide a graphical fingerprint for a series of detected shots, and are used to differentiate whether the shots originate from friendly targets or enemy/unknown targets. Although the graph in FIG. 3 illustrates that the shots 71-80 corresponding to the bearings 61-70 are acquired over a time span of under 1 second, those having ordinary skill will appreciate that more or fewer shots may be acquired over a shorter or longer time interval in accordance with the present invention.

In the illustrated example, the shots 71-79 corresponding to bearings 61-69 all have a substantially equal intershot timing and, thus, are correlated by the burst definition element 14 into a single burst 90. On the other hand, the shot 80 corresponding to bearing 70 has an intershot timing greater than the intershot timing Δtₛₕₒₜ of the shots 71-79 and, thus, is not correlated into the single burst 90. Accordingly, the bearing 70 and the shot 80 corresponding to the bearing are ignored for future computations.

Once all the bearings 61-69 associated with the target 56 and along the baseline of the flight path 54 have been obtained, a shot correlation element (not shown) and a position aggregation element (not shown) cooperate to calculate an estimated position of the target 56 from each of the bearings 61-69 using known methodologies. The aircraft 52, therefore, is capable of identifying that a series of weapon fire originates from a single source and then estimating a position of that source.

Once it is determined that a series of shots 71-79 are grouped in a single burst 90 and therefore originate from a single source of weapon fire, the firing characteristic element 16 evaluates the shots in the burst 90 and determines a firing characteristic of the shots. The firing characteristic element 16 may, for example, rely on the intershot timing Δtₛₕₒₜ of the detected shots in the burst 90. In particular, the firing characteristic element may determine the fire cycle frequency of the weapon fire from the target 56. The fire cycle frequency of a particular weapon is the mechanical rate of fire, or how fast the weapon “cycles”, i.e., loads, locks, fires, unlocks, and ejects. Using algorithms such as Fast Fourier Transform, the firing characteristic element 16 can use the intershot timing Δtₛₕₒₜ of the detected shots within the burst 90 to determine the fire cycle frequency of the weapon from which the shots originate. This parameter can then be compared to known fire cycle frequencies to differentiate between weapon fire originating from friendly fire and that from enemy or unknown fire.

The firing characteristic element 16 may also calculate the flash intensity of the shots within the burst 90. The flash intensity will be based on the magnitude of the muzzle flash as well as the range at which the flash was detected, i.e., how far away the muzzle flash occurred from the sensor on the aircraft 52.

FIG. 4 graphically illustrates different automatic fire cycle frequencies and their flash intensity for both known coalition forces weapons as well as known alternate, e.g., enemy, weapons. For example, the cyclic firing rates of coalition force weapons, indicated at 95, include 450 rounds per minute (rpm) for the M60, 725 rpm for the M16A2, and 750 rpm for the G36C. Exemplary firing rates for alternative weapons, indicated at 96, include 600 rpm for the AK47, 650 rpm for the RPK74, and 680 rpm for the AKS-74U.

Based on the computed firing cycle frequency from the firing characteristic element 18 and the flash intensity of the detected shots within the burst 90, the weapon identification element 18 is able to determine the type or class of weapon used by the target 56. If the weapon identification element 18 determines that the type or class of weapon belongs to friendly or coalition forces, no countermeasures are taken by the aircraft 52. If, on the other hand, the weapon identification element 18 determines that the type or class of weapon belongs to an alternative weapon, e.g., those carried by enemy forces, it may be necessary to take appropriate countermeasures. If such countermeasures are deemed necessary, the estimated position of the target 56 previously computed by the aircraft 52 can be used accordingly.

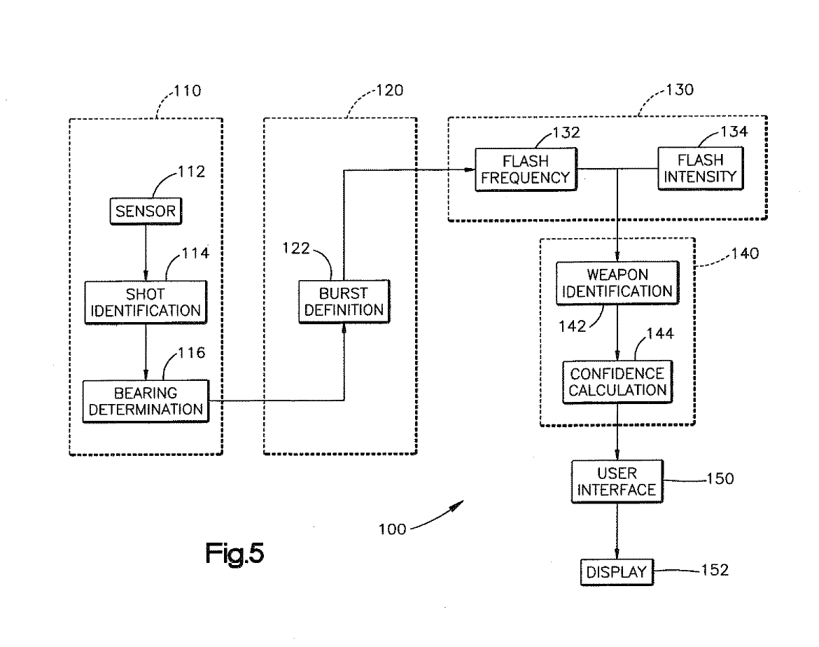

FIG. 5 illustrates an exemplary target location system 100 for locating targets to an aircraft that are located on the ground. The system includes a bearing determination element 110 that is configured to determine associated bearings from an aircraft for each of a plurality of detected shots from a target at ground level. The bearing determination element 110 includes a sensor 112 that detects weapon fire from the ground. For example, the sensor 112 can include one or more image sensors that detect light in one or both of the visible spectrum and the infrared spectrum. A shot identification element 114 is configured to receive data from the sensor 112 and identify shots within the sensor data. The shot identification element 114 can also identify the respective times at which the identified shots were taken.

A bearing determination element 116 is configured to determine an associated bearing from the aircraft for each identified shot. In one implementation, one or more images associated with each shot can be analyzed to determine a bearing to the shot from the aircraft from the known properties of one or more image sensors and the position of the shot within each image. A location determination element (not shown) is configured to determine a relative location of the aircraft at the associated time of each shot. The location determination element can include, for example, a GPS assembly, an operative connection to a GPS assembly associated with the aircraft, or an operative connection with one or more other aircraft systems to continuously provide velocity and heading updates to the system 100.

The system further includes a shot correlation element 120 having a burst definition element 122 configured to correlate shots that represent a single burst of shots from an automatic weapon. A series of shots can be reviewed to determine intershot intervals between consecutive shots in the series. In the illustrated implementation, a series of shots having a regular intershot interval can be correlated into a single burst. Alternatively, shots that are spatially and temporally proximate can be grouped, with a group being defined when a series of shots are within a given degree of arc of the sensor, consecutive shots are separated by no more than a first threshold time period, and the entire series has a time period less than a second threshold time period.

A firing characteristic element 130 is provided to compute and/or compile firing characteristics of the shots in the burst 90. For example, a flash frequency element 132 is configured to determine the fire cycle frequency of the weapon fire from the target 56 based on the intershot timing Δtₛₕₒₜ. A flash intensity element 134 is configured to determine the intensity of the muzzle flash from the weapon fire based on the magnitude of the muzzle flash and the range at which the sensor detects the flash from the weapon fire. The flash intensity element 134 may be part of the sensor 112 in the bearing determination element 110 and merely transmit the relevant data to the firing characteristic element 130 or the flash intensity element may be completely separate from the sensor.

A weapon identification element 140 is configured to determine whether the series of detected shots from the weapon fire is friendly fire or enemy fire. In particular, based on the calculated fire cycle frequency of the weapon fire and/or the flash intensity, a weapon identification element 142 can correlate these values to cycle frequencies and flash intensities of known automatic weapons. The weapon identification element 142 therefore differentiates the weapon fire from the target in order to identify whether the weapon fire originates from friendly fire or enemy fire and, thus, whether appropriate countermeasures need to be taken by the aircraft 54.

The weapon identification element 140 can further include a confidence calculation element 144 that calculates a confidence measure for the determined weapon type or class of the target. For example, a standard deviation associated with flash intensity and/or intershot timing can be calculated, and from these values, a desired confidence range (e.g., 95%) can be determined. The weapon identification, along with the calculated confidence, can be displayed to a user at an associated display 150 via a user interface 152. The user can then initiate any appropriate countermeasures to the target based on the determined weapon identification of the target and the confidence in that identification.

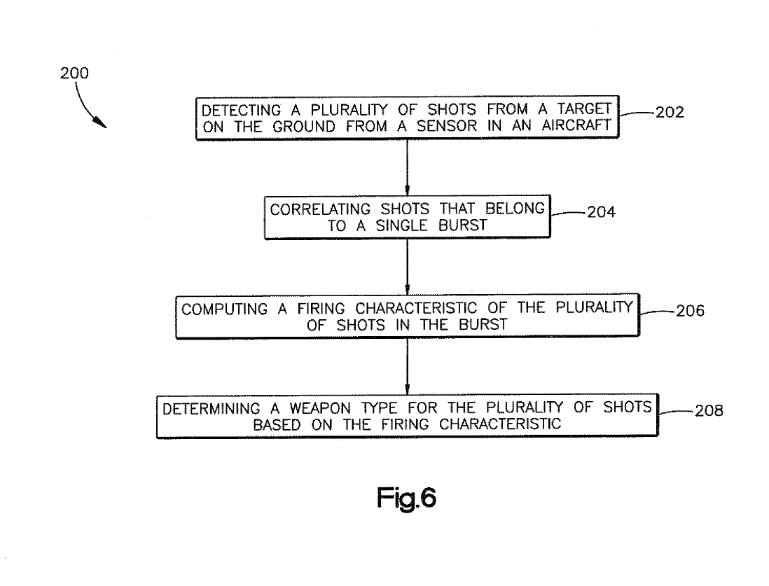

In view of the foregoing structural and functional features described above, a methodology in accordance with various aspects of the present invention will be better appreciated with reference to FIG. 6. While, for purposes of simplicity of explanation, the methodology of FIG. 6 is shown and described as executing serially, it is to be understood and appreciated that the present invention is not limited by the illustrated order, as some aspects could, in accordance with the present invention, occur in different orders and/or concurrently with other aspects from that shown and described herein. Moreover, not all illustrated features may be required to implement a methodology in accordance with an aspect the present invention.

FIG. 6 illustrates a method 200 for differentiating weapon fire from targets on the ground to an aircraft in accordance with an aspect of the present invention. At 202, a plurality of shots from a target on the ground is detected from a sensor in the aircraft. At 204, shots that belong to a single burst are correlated. At 206, a firing characteristic of the plurality of shots in the burst is computed. At 208, a weapon type is determined for the plurality of shots based on the firing characteristic.

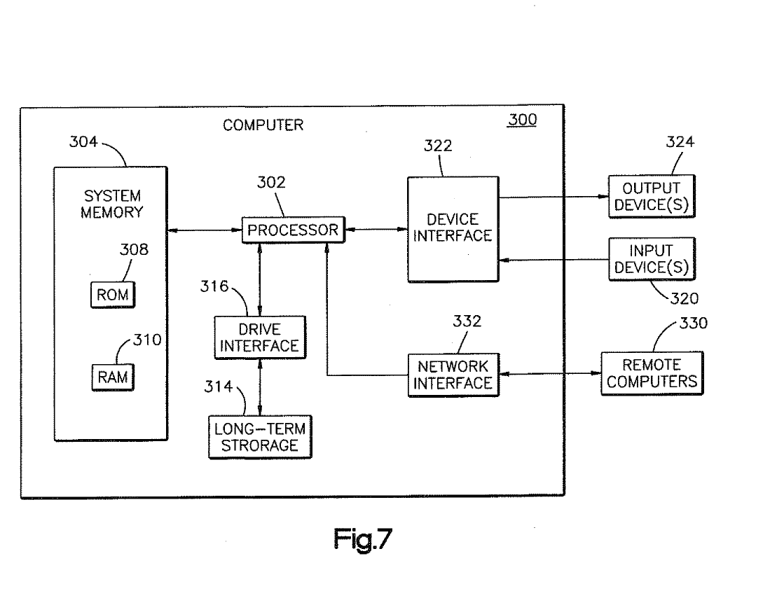

FIG. 7 illustrates a computer system 300 that can be employed to implement systems and methods described herein, such as based on computer executable instructions running on the computer system. The computer system 300 can be implemented on one or more general purpose networked computer systems, embedded computer systems, routers, switches, server devices, client devices, various intermediate devices/nodes and/or stand alone computer systems. Additionally, the computer system 300 can be implemented as part of the computer-aided engineering (CAE) tool running computer executable instructions to perform a method as described herein.

The computer system 300 includes a processor 302 and a system memory 304. Dual microprocessors and other multi-processor architectures can also be utilized as the processor 302. The processor 302 and system memory 304 can be coupled by any of several types of bus structures, including a memory bus or memory controller, a peripheral bus, and a local bus using any of a variety of bus architectures. The system memory 304 includes read only memory (ROM) 308 and random access memory (RAM) 310. A basic input/output system (BIOS) can reside in the ROM 308, generally containing the basic routines that help to transfer information between elements within the computer system 300, such as a reset or power-up.

The computer system 300 can include one or more types of long-term data storage 314, including a hard disk drive, a magnetic disk drive, (e.g., to read from or write to a removable disk), and an optical disk drive, (e.g., for reading a CD-ROM or DVD disk or to read from or write to other optical media). The long-term data storage can be connected to the processor 302 by a drive interface 316. The long-term storage components 314 provide nonvolatile storage of data, data structures, and computer-executable instructions for the computer system 300. A number of program modules may also be stored in one or more of the drives as well as in the RAM 310, including an operating system, one or more application programs, other program modules, and program data.

A user may enter commands and information into the computer system 300 through one or more input devices 320, such as a keyboard or a pointing device (e.g., a mouse). These and other input devices are often connected to the processor 302 through a device interface 322. For example, the input devices can be connected to the system bus by one or more a parallel port, a serial port or a universal serial bus (USB). One or more output device(s) 324, such as a visual display device or printer, can also be connected to the processor 302 via the device interface 322.

The computer system 300 may operate in a networked environment using logical connections (e.g., a local area network (LAN) or wide area network (WAN) to one or more remote computers 330. A given remote computer 330 may be a workstation, a computer system, a router, a peer device or other common network node, and typically includes many or all of the elements described relative to the computer system 300. The computer system 300 can communicate with the remote computers 330 via a network interface 332, such as a wired or wireless network interface card or modem. In a networked environment, application programs and program data depicted relative to the computer system 300, or portions thereof, may be stored in memory associated with the remote computers 330.

It will be understood that the above description of the present invention is susceptible to various modifications, changes and adaptations, and the same are intended to be comprehended within the meaning and range of equivalents of the appended claims. The presently disclosed embodiments are considered in all respects to be illustrative, and not restrictive. The scope of the invention is indicated by the appended claims, rather than the foregoing description, and all changes that come within the meaning and range of equivalence thereof are intended to be embraced therein.

Having described the invention, we claim the following:

1. A method for differentiating weapon fire from targets located on the ground to an aircraft, comprising:
detecting a plurality of shots from a target on the ground from a sensor in the aircraft;
correlating shots that belong to a single burst;
computing a firing characteristic of the plurality of shots in the burst; and
determining a weapon type for the plurality of shots based on the firing characteristic.

2. The method of claim 1, wherein the step of computing the firing characteristic comprises computing at least one of flash intensity and intershot timing of the plurality of shots in the burst.

3. The method of claim 2 wherein the step of computing the intershot timing of the plurality of shots comprises computing the time difference between consecutive shots of weapon fire in the burst.

4. The method of claim 3, wherein the step of computing the intershot timing of the plurality of shots comprises computing the time difference between peak weapon flash intensity values for consecutive shots in the burst.

5. The method of claim 1, wherein the step of determining a weapon type for the plurality of shots based on the firing characteristic comprises correlating a computed intershot timing of the plurality of shots with known weapon fire cycle frequencies.

6. The method of claim 1 further comprising calculating a confidence measure associated with the determined type of weapon fire of the target.

7. The method of claim 1 further comprising calculating an estimated position for the target.

8. A system for differentiating weapon fire from targets on the ground to an aircraft, comprising:
a weapon fire detection element configured to detect a plurality of shots from a target on the ground to the aircraft;
a burst definition element configured to correlate the plurality of shots that belong to a single burst;
a firing characteristic element configured to compute a firing characteristic of the plurality of shots in the burst; and
a weapon identification element configured to determine the weapon type for the plurality of shots in the burst based on the firing characteristic.

9. The system of claim 8, wherein the burst definition element is configured to identify a series of shots representing a single burst of shots from an automatic weapon.

10. The system of claim 8 further comprising a bearing determination element comprising:
a shot identification element configured to receive data from an associated sensor and identify shots and respective associated times of the shots from the sensor data;
a bearing determination element configured to determine an associated bearing from the aircraft for each identified shot; and
a location determination element configured to determine a relative location of the aircraft at the associated time of each shot.

11. The system of claim 10, wherein the sensor comprises an image sensor that detects light in one of the visible spectrum and the infrared spectrum.

12. A computer readable medium storing executable instructions that can be executed by a processor to differentiate weapon fire from targets on the ground to an aircraft using sensor data, the executable instructions comprising:
a burst definition element configured to determine if a plurality of shots detected from the ground belong to a single burst; and
a weapon identification element for identifying the type of weapon from which the detected shots in the single burst originate.

13. The computer readable medium of claim 12, the executable instructions further comprising:
a shot identification element configured to receive data from an associated sensor and identify shots and respective associated times of the shots from the sensor data;
a bearing calculator configured to determine an associated bearing from the aircraft for each identified shot; and
a location determination element configured to determine a relative location of the aircraft at the associated time of each shot.

14. The computer readable medium of claim 12, further comprising a user interface configured to provide the identified weapon type to an associated display for display to a user.
